(19) United States
(12) Patent Application Publication
(10) Pub. No.: US 2025/0061034 A1
(43) Pub. Date: Feb. 20, 2025

(54) METRICS, EVENTS, ALERT EXTRACTIONS FROM SYSTEM LOGS

(71) Applicant: Selector Software, Inc., Santa Clara, CA (US)

(72) Inventors: Nitin Kumar, Santa Clara, CA (US); Surya Chandra Sekhar Nimmagadda, Santa Clara, CA (US); Debashis Mohanty, Santa Clara, CA (US)

(21) Appl. No.: 18/449,596

(22) Filed: Aug. 14, 2023

(51) Int. Cl. G06F 11/30; G06F 11/34

(52) U.S. Cl. CPC G06F 11/3086; G06F 11/3476

(57) ABSTRACT

Systems, apparatuses, and methods for analyzing log data are described. A processing unit ingests data blocks multiple data sources associated with a network-connected device. Each data block is associated with contextual meta tags identified from the ingested data. Further, one or more entities associated with the network-connected device are identified and for each entity a taxonomy is created. The taxonomy comprises a plurality of categories, each category comprising at least one contextual meta tag. Dashboards for presentation of processed log data are generated based at least in part on the taxonomy.

### BACKGROUND

### Description of the Related Art

Network operation engineers must deal with log messages generated by multiple devices and technologies. Log messages carry valuable information, but logs being unstructured by nature makes it challenging to automate the extraction of log metadata. Standard procedures used for log metadata extraction are based on regular expressions that may be used to find fields of interest within log data. This has always been an arduous process for several reasons. First, building expressions for extracting valuable information from raw log data can be complex. Second, these expressions need to be supported and changed over time. This can be a challenge since personnel that created these expressions may not have required documentation in place in case a reverse engineering effort is required, e.g., due to change in data owners. To complicate matters further, vendors may change the format for their log data which may cause regular expressions to stop working and prevent the extraction of key information required.

In view of the above, improved systems and methods for data management for log data are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of an exemplary network implementation of an operations monitoring system.

FIG. 2 is a block diagram of exemplary implementation of various units of the operations monitoring system.

FIG. 3 is a block diagram illustrating workings of a data aggregator unit of the operations management system.

FIG. 4 is a block diagram illustrating workings of a data analyzer unit of the operations management system.

FIG. 5 illustrates an exemplary data correlation procedure.

FIG. 6 is an exemplary method for generating query-based dashboards for inspection of performance metrics of a network service.

FIG. 7 is an exemplary method of generating training data from log data.

FIG. 8 is an exemplary method of generating mined data using training data.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for analyzing log data are disclosed. A computing system ingests data from data sources, the data at least including log data. In one implementation, the log data includes unstructured textual data blocks, such that each data block is processed by the system. For instance, the system normalizes and clusters each data block to identify one or more data patterns. The system further generates a set of contextual meta tags from the plurality of data blocks and associates each data block with a contextual meta tag. In an implementation, the system also utilizes entity-specific parameters, for example, inventory information, entity-specific metadata, etc., to identify entities associated with the log data. The system can create, for each entity, a taxonomy including a plurality of categories, each category including at least one contextual meta tag. The data blocks are segregated into these categories such that corresponding visual information can be created based on a priority level for each category included in the taxonomy.

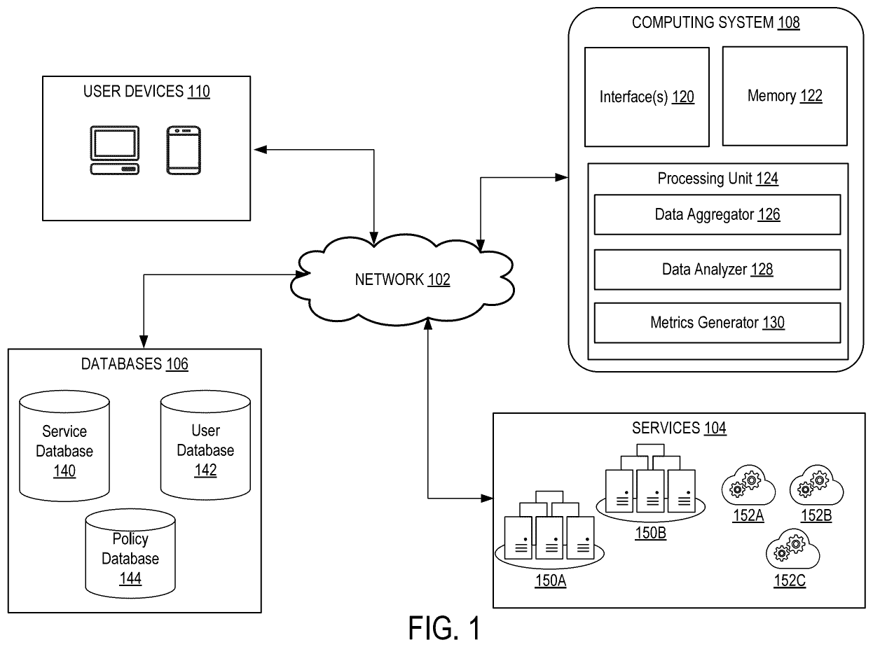

FIG. 1 illustrates an exemplary network implementation 100 for functioning of a computing system 108 (alternatively referred to as operations management system or OMS 108). In an implementation, the operations management system 108 is configured to manage operations and maintenance of one or more services 104, over a network 102. In one implementation, services 104 managed by the operations management system 108 can include one or more physical infrastructures, e.g., datacenter 150A and datacenter 150B (collectively referred to as datacenters 150). Further, the services 104 can also include software services, e.g., cloud-based services 152A, 152B, and 152C (collectively referred to as cloud services 152). In an example, datacenters 150 may include on-site datacenters such as Information Technology (IT) equipment, such as computers, networks, and storage systems, and are located and used to support the operation of a particular business. The equipment in the datacenters 150 can be used to run important applications, services, and store critical data for the business. Similarly, cloud services 152 include services that may allow businesses to access and use IT resources, such as applications, development platforms, servers, storage, and virtual desktops, over the internet or a dedicated network. Other examples of services 104 are contemplated.

The OMS 108 is configured to provide analysis of the workings of the services 104 to one or more user devices 110 over the network 102. In one example, the user devices 110 include devices used by IT administrators, network engineers, and/or maintenance personnel to inspect performance of the services 104, either on-site or remotely. User devices 110 can include personal computers, digital assistants, smartphones, tablets, and laptops, can be connected to the network 102 or operate independently. These devices may also have various external or internal components, like a mouse, keyboard, or display. User devices 110 can run a variety of applications, such as word processing, email, and internet browsing, and can be compatible with different operating systems like Windows or Linux.

The operations management system 108 is further connected to one or more databases 106, over the network 102, such that data generated as a result of execution of instructions by the operations management system 108, is stored in at least one of the databases 106. In one implementation, the databases 106 can be internal to the operations management system 108. The databases 106 includes a service database 140, a user database 142, and a policy database 144. The service database 140, in an implementation, can be used to store data associated with one or more of the services 104. The data can include business data, location data, equipment data, maintenance data, and the like for one or more services 104. The user database 142, in an implementation, stores data associated with users of the user devices 110. The data can include user registration data, device-type data, user designation data, and the like. Further, policy database 144 can store data associated with policies and heuristics-based rules, that can be used by the operations management system 108 to generate on-demand dashboards (i.e., graphical interfaces providing visual information) for the user devices 110.

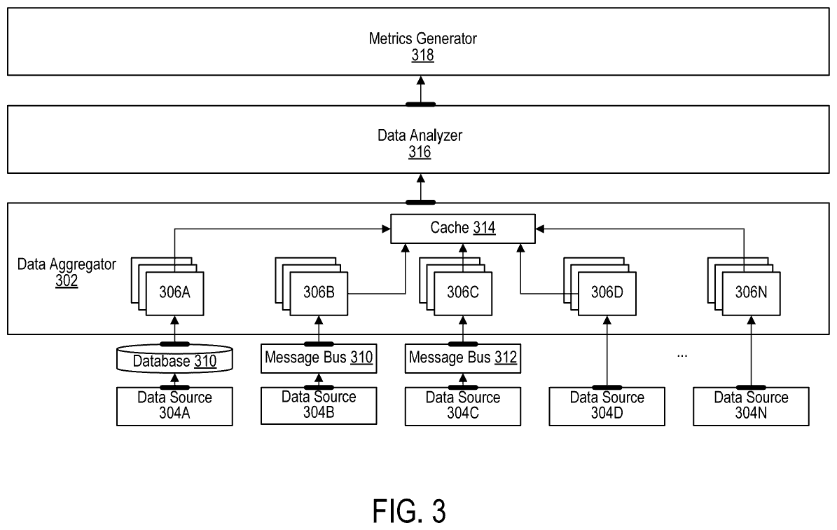

As shown in the figure, the operations management system 108 includes one or more interface(s) 120, a memory 122, and a processing unit 124. In an implementation, the one or more interface(s) are configured to display data generated as a result of the processing unit 124 executing one or more programming instructions stored in the memory 122. The processing unit 124 further includes data aggregator 126, data analyzer 128, and metrics generator 130. The data aggregator 126 is configured to ingest data associated with one or more service of the services 104, from a variety of data sources (as detailed in FIG. 3). In an implementation, the ingested data is indicative of operational parameters of the services 104 being monitored. The data, in an example, can include information pertaining to events, logs, metrics, and the like. In an implementation, the data is heterogenous, in that, the content as well as the format of the data is non-consistent. The data aggregator 126 is configured to ingest such heterogenous data from multiple data sources, such as, network management interface data, data services pipeline data, time-series data, and the like. The data can also include data from existing data logging and information technology (IT) monitoring systems. In an implementation, data from each different data source is collected by the data aggregator 126 using one or more data collection engines, as further described in FIG. 3. The collected data is processed and can be stored by the data aggregator 126, e.g., in the service database 140.

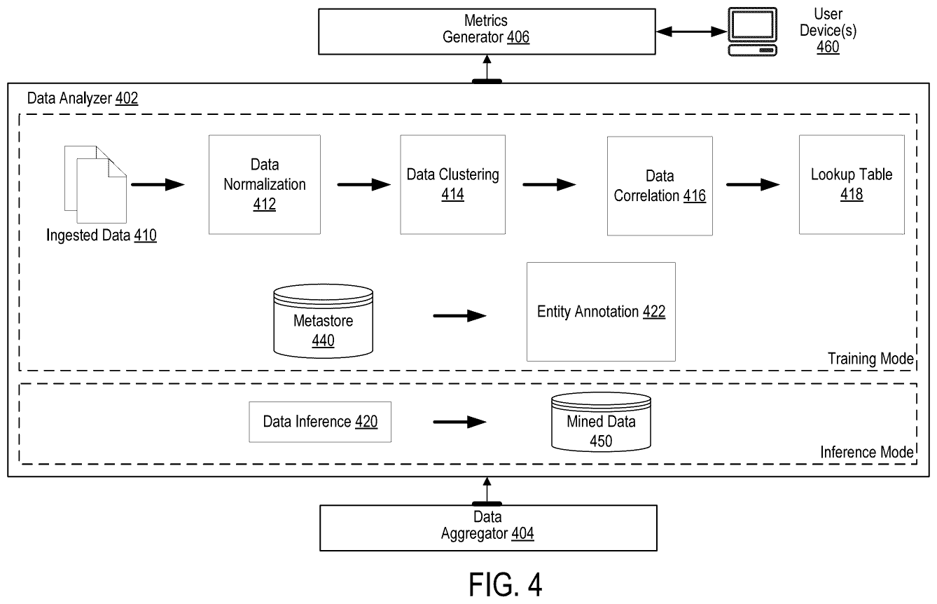

The data analyzer 128 analyzes the collected data and provides an abstract view of the data, for example, by decoupling the data from its source. In an implementation, the abstract view of the data by decoupling of data can be facilitated by the use of virtual machines and/or containers. The decoupled data can then be normalized by the data analyzer 128 and redirected to specific storage repositories (not shown), created for each type of data. The decoupled and normalized data, in an implementation, is utilized by the data analyzer 128 to generate contextual metadata (e.g., meta tags) associated with a plurality of categories (e.g., events, warnings, errors, or other information) for inspection of one or more services 104, in real-time or near-real time. In an implementation, the contextual meta tags are generated in the form of labels, such that the collected data, when infused with these labels, can be cross-correlated to monitor each category for the one or more services 104 (as detailed in FIG. 4).

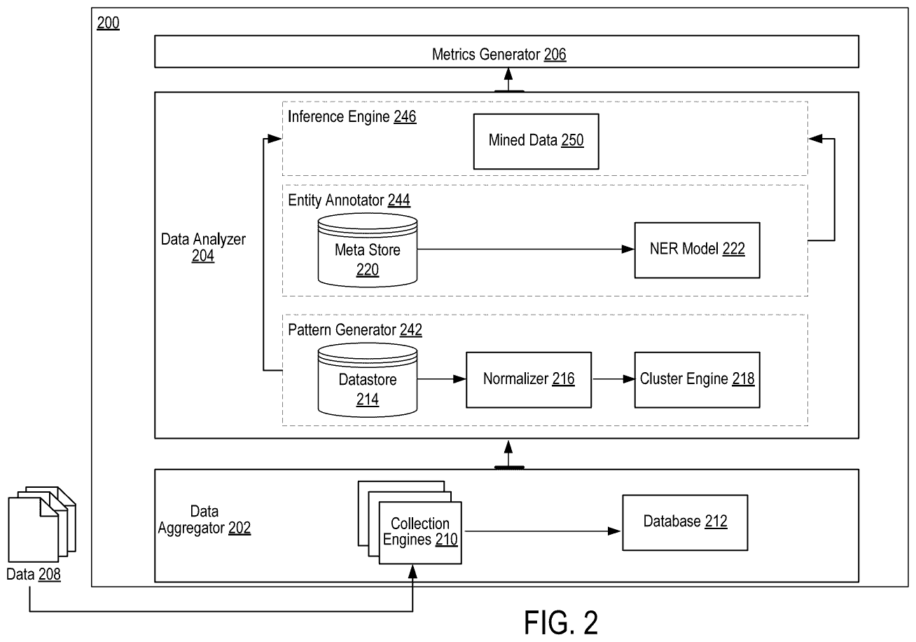

As described in the foregoing, the ingested data at least includes log data. In an implementation, the log data includes unstructured textual data blocks, such that each data block is processed by the data analyzer 128. For instance, the data analyzer 128 is configured to normalize each data block to identify one or more data patterns. The data analyzer 128 further generates a set of contextual meta tags from the plurality of data blocks and associates each data block with a contextual meta tag. In an implementation, data analyzer 128 utilizes entity-specific parameters, for example, inventory information, entity-specific metadata, etc., to identify entities associated with the log data. Further, the data analyzer 128 creates, for each entity, a taxonomy including a plurality of categories, each category including at least one contextual meta tag. The data blocks are segregated into these categories such that dashboards can be created based on a priority level for each category included in the taxonomy. Generation of meta tags and creation of taxonomies for the ingested data blocks is further described in FIGS. 2 and 4.

In an implementation, a dashboard generated by the metrics generator 130 includes a visual representation of data processed by data analyzer 128, such that this visual representation provides a consolidated view of key information and metrics. The dashboards are presented on the user device 110 in the form of a user interface that displays various charts, graphs, tables, and other visual elements to convey relevant insights and trends. The dashboards can be generated by the metrics generator 130 to present data in a concise, easily digestible format, allowing users to quickly understand and analyze information. Further, these dashboards can be customized to suit specific user roles or requirements, providing personalized views and insights. Although the description herein is presented with respect to dashboards, in various alternative implementations, the metrics generator 130 can also provide other options instead of or in combination with the dashboards for presenting data. For example, such substitute options can include data storytelling boards, interactive data tools, NLP interfaces, data visualization libraries, and the like. Such implementations are contemplated.

The metrics generator 130, in an implementation, is configured to generate the dashboards for display on one or more graphical user interfaces of the user devices 110. The dashboards, in one implementation, are generated based at least in part on the priority level of each category of the plurality of categories. The dashboards can facilitate a user of a given user device 110 (such as an IT administrator), to root-cause an issue with a given service 104 and troubleshoot the issue, without the requirement of additional monitoring tools or applications. Further, the dashboards are updated in real-time such that every event occurrence for a given service 104 is accessible to the user concurrently, thereby reducing time spent on root-causing of the issue. The user can simply send plain text messages (e.g., using an instant messaging application) from their user device 110, to request for information on various performance metrics for a service 104. Based on the received messages, the metrics generator 130 can update existing dashboards and/or create new dashboards on the fly to provide important insights regarding performance of the service 104, to the user device 110.

In one implementation, the OMS 108 can be a standalone computing system. In another implementation, the OMS 108 can take form of a processing unit (e.g., memory 124) of a computing system comprising of a central processing unit and a system memory (e.g., memory 122). Such implementations are contemplated.

Turning now to FIG. 2, a block diagram of exemplary implementation of various units of an operations management system 200 (or “OMS 200”) is illustrated. For the sake of brevity, FIG. 2 describes the detailed working of a data aggregator 202, a data analyzer 204, and a metrics generator 206, of the OMS 200. Other processing and non-processing units of the OMS are similar to as that described for computing system 108 in FIG. 1.

In an implementation, the OMS 200 can have access to a variety of data sources (as shown in FIG. 3), for the data aggregator 202 to ingest data 208 using a set of custom-built collection engines 210. The collection engines 210, in several implementations, can be configured for ingesting data 208 from one or more data sources (not shown), either by pulling data 208 from the data sources or using push notifications to collect data 208 from the data sources.

In an example, the one or more data sources can include IT monitoring and data logging systems. In an implementation, data aggregator includes pre-integrated collection engines 210 for each different type of data source, such that heterogenous data 208 from varied data sources can be easily collected for analysis. In one implementation, data 208 can also be collected directly from one or more network or cloud services (e.g., services 104 of FIG. 1) being monitored.

In an implementation, the data aggregator 202 can connect to existing inventory or Configuration Management Database (CMDB) tool associated with an entity being monitored. According to the implementation, the data 208 collected from such tools can include static inventory definitions from a file or dynamic definitions via an Application Programming Interface (API). The data aggregator 202 can also integrate with an existing Netbox instance and/or provide inventory as a service using an internal Netbox instance (not shown).

The collected data 208 is used to create a database 212, such that data from the database 212 can be used by one or more components of the OMS 200 for real-time telemetry and enrichment. Further, each collection engine 210, in an implementation, can be cloud-native, such that scaling out of the collection engines 210 for new types of data 208 is possible. The collection engines 210 are configured to provide an entry point for ingestion of data into the OMS 200. Although FIG. 2 describes ingested data primarily including log data, different types of data 208 and associated collection engines 210 are described in detail with respect to FIG. 3.

In an implementation, the collected log data 208, from the database 212 can be accessed by the data analyzer 204 to create contextual metadata. The collected log data 208, in one example, may lack context and therefore enrichment of the log data 208 with context-based meta tags is required. To this end, the data analyzer 204 is configured to access different sets of data from the database 212, store the accessed data in datastore 214, and process the data. As shown in the figure, the data analyzer 204 further includes a pattern generator 242, an entity annotator 244, and an inference engine 246.

In one implementation, the data analyzer 204 is configured to analyze ingested log data 208 in two modes. In a training mode, the data analyzer 204 analyzes data to generate training data. That is, during the training mode, the data analyzer 204 analyzes data to generate training data, such that the training data includes each block of log data correlated with a meta tag and an associated entity. Further, during an inference mode, the data analyzer 204 uses previously generated training data to process incoming log data, in order to generate actionable insights from the incoming log data in the form of mined data. In one example, each time new logs are encountered by the OMS 200, the data analyzer 204 is configured to utilize the training data to identify data patterns and correlate these data patterns with entities. In an implementation, the training data is continuously modified even when the OMS 200 is operating in the inference mode. For instance, training data can be modified responsive to factors such as user feedback, change in versions of log data, change in entity information, change of personnel, system updates, and the like. Each time the training data is updated, the OMS 200 can automatically update the processing of incoming log data accordingly.

In an implementation, when the OMS 200 is operating in the training mode, the pattern generator generates data patterns from raw log data (e.g., log data 208). The pattern generator 242 includes normalizer 216 and cluster engine 218. In an example, raw log data ingested by OMS 200 can be unstructured and unformatted data. In order to further analyze the log data to generate training data, normalizer 216 is configured to normalize each data block included within the ingested log data. In an implementation, normalizer 216 normalizes data blocks of ingested log data using a user-defined function (UDF) custom normalization. The normalized data blocks are then clustered by cluster engine 218 to generate data patterns. Based on the generated data patterns, the data analyzer 204 identifies meta tags associated with each data pattern. In an implementation, the meta tags include events, warnings, or other information as identified from the data patterns. For the sake of brevity, the description is limited to meta tags including only events, however, other tags are not precluded.

In another implementation, the generated data patterns are re-clustered by cluster engine 218 to generate pattern groups. According to the implementation, during clustering of both normalized data to data patterns and data patterns to pattern groups, the cluster engine 218 uses a density-based clustering algorithms. The density algorithms can take different measurements to calculate the clustering. For the clustering of normalized data into data patterns, Euclidean distance clustering may be used. For clustering data patterns into pattern groups, a cosine similarity is used as a distance measurement.

In one implementation, each data pattern and pattern group and their associated meta tags are stored as a lookup table by the data analyzer 204. For example, the lookup table includes patterns or pattern groups and their corresponding events. Further, during inference mode, as new logs come in, normalizer 216 can extract patterns in the logs. These patterns are then correlated with the lookup table to identify corresponding events.

In one implementation, entity annotator 244 utilizes entity specific parameters to identify entities in log data. For instance, the entity annotator 244 is configured to use named entity recognition (NER) models 222 to train the OMS 200 using entity recognition. In one implementation, the entity annotator 244 uses entity specific parameters stored in the meta store 220 to extract entity identifiers and create a dictionary of labels. In one example, the meta store 220 includes tags such as device name, site information, BGP, Autonomous System Numbers (ASN), IP addresses, and the like. The entity annotator 244 uses the NER models 222, that are trained using data from the meta store 220, to further identify tags based on the training. In an implementation, the lookup table indicative of log data patterns with corresponding events as well as tags indicative of entities are stored as training data.

In an implementation, based on the training data, the inference engine 246 creates mined data 250. During inference mode, as new logs are ingested, the inference engine 246 identifies events corresponding to data patterns and pattern groups within the ingested logs, based on the training data. Further, each identified event is correlated with a given entity, again using the training data. The association between identified events and corresponding entities are stored as mined data 250.

In one implementation, the data analyzer 204 is configured to generate a taxonomy of categories for each identified entity using the mined data 250. According to the implementation, the taxonomy include categories, wherein each category is based on a particular meta tag. As described earlier, meta tags can include events, warnings, alerts, performance range, malfunction information, device status, and the like. For every entity identified within the mined data 250, the data analyzer 204 generates a taxonomy including all meta tags subsumed within the mined data 250 as unique categories. Thereafter, blocks of the mined data 250 are segregated into at least one category and a priority level for each category is determined. In an implementation, if data analyzer 204 fails to segregate a data block into a category, the taxonomy is modified in real-time.

In an implementation, the metrics generator 208 is configured to create on-demand dashboards based on the taxonomy. According to the implementation, these dashboards are created responsive to requests received from a user device to inspect one or more performance metrics associated with a given service or a part of an infrastructure of the given service. For example, the metrics generator 208 can create a dashboard illustrating data patterns identified within the log data, associated with corresponding events. The dashboard can present each event occurring for a given entity, and corresponding log data patterns emerging as a result of the event. In another example, the metrics generator 208 generates a dashboard depicting event counts for a given period of time for each identified entity. Other dashboards are implemented.

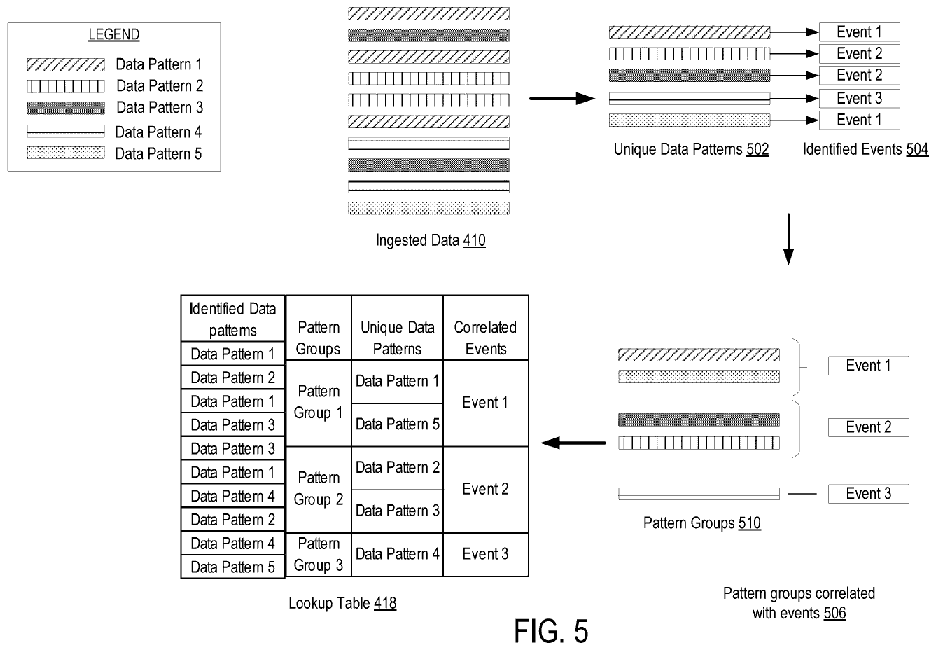

In one implementation, the dashboards are presented based on the priority level associated with each category of the taxonomy. Further, in case of anomalies found in the data, categories with higher priorities may be highlighted in the created dashboards. The formation of dashboards is further explained with respect to FIG. 5.

In an implementation, a user device using the mined data 250 can readily identify log data patterns and associated entities. The OMS 200 automatically extracts and bucketizes patterns into different buckets such as info, warning, error. In each of these buckets, the implementation automatically extracts names of the entity to create a dictionary of labels. In this model, user can track number of info, warning, errors for each unique extracted label.

Referring now to FIG. 3, a block diagram illustrating workings of a data aggregator unit of an operations management system (OMS) is illustrated. As described in the foregoing, a data aggregator unit, such as the data aggregator 302 of FIG. 3, is configured to ingest heterogenous data from multiple data sources, the data representative of operational information associated with one or more services (e.g., a network-based service or a cloud-based service). In an implementation, the data sources can either belong to third-party monitoring services and/or data can be ingested directly from the service being monitored.

In the implementation shown in FIG. 3, the data aggregator 302 ingests data from a plurality of data sources, including data sources 304A-N (collectively referred to as data sources 304). In an implementation, each different data source 304 can contain data in different formats that may be generated as a result of operations executed within the service being monitored. Further, collection engines 306A-N may each be associated with a particular data source 304. In an implementation, data collection engines 306 include systems designed to gather, process, and store data from various data sources 304. The data collection engines 306 are configured to collect and store data from a single source, or can include complex systems that can handle data from multiple sources and perform advanced analytics on that data. In an implementation, some data collection engines 306 may be designed to analyze smaller services (e.g., IT operations of a small or mid-sized organization), while other data collection engines 306 may be intended for use by large organizations with sophisticated data needs. In several implementations, data collection engines 306A-N can be implemented in a variety of ways, including through software programs, web applications, or specialized hardware systems (not shown). They may be used in combination with other tools, such as data visualization software or machine learning algorithms, to analyze and interpret the collected data.

The ingested data, in an implementation, can be varied in terms of source of data and type of data. Some non-limiting examples of ingested data are described as follows:

Data Source 304A: Network management interface data-Network management interface data refers to data that is generated as a result of protocols used to manage and operate network devices. For example, network management interfaces can stream data from one or more network devices and provide features for managing the operational and configuration states of switches.

Data Source 304B: Data from data pipeline services-Data pipeline services like Kafka™ are used to create data pipelines and applications that stream data. One example of how a data pipeline can be used is to move data between different systems by collecting and storing streaming data. These services can also help create a platform that communicates and processes data between two services or applications.

Data Source 304C: Time Series Data-Static data is data that has a specific start and end time and is only relevant within a certain time frame. Time series data, on the other hand, is a series of data points that measure the same thing over a set period of time. It can be thought of as a series of numerical values, each with its own time stamp and set of labeled dimensions. Time series data is becoming increasingly common, and time series databases have been growing in popularity among developers in recent years. While static data is relatively straightforward to analyze, time series data is more complex because it depends on various dynamics and often involves analyzing data over time to identify anomalies.

Data Source 304D: Representational state transfer (REST API) data-A REST API is a type of application program interface that follows a specific architectural style and uses HTTP requests to access and manipulate data. This data can be accessed and modified through various actions such as GET, PUT, POST, and DELETE, which allow for the reading, updating, creating, and deleting of resources.

Data Source 304N: Monitoring tool data-Data and IT monitoring tools help organizations extract value from their server data, enabling efficient management of applications, IT operations, compliance, and security monitoring. These tools may include of an engine at their core that collects, indexes, and manages large amounts of data, which can be in any format and can reach terabytes or more per day. Such tools can analyze data dynamically, creating schemas on the fly, allowing users to query the data without needing to understand its structure beforehand. It can be used on a single laptop or in a large, distributed architecture in an enterprise data center. These tools can provide a machine data fabric, including forwarders, indexers, and search heads, which allows for real-time collection and indexing of machine data from any network, data center, or IT environment.

Other types of data from various other data sources are contemplated.

In an implementation, each different type of data received from data sources 304 is ingested by the data aggregator 302 using a particular data collection engine 306, as shown. Further, the data may be ingested using a dedicated message bus, through a datastore associated with the data source, and/or directly through the data source without the use of auxiliary infrastructure. As shown in FIG. 3, data from data source 304A may be collected in database 308 and retrieved from the collection engine 306 A through the database 308. Further, messages buses 310 and 312 may be configured between collection engine 306B and data source 304B, as well as between collection engine 304C and data source 304C. As described in the foregoing, each collection engine 306, in an implementation, can be cloud-native, such that scaling out of the collection engines 304 for new types of data may be possible. The collection engines 306 are configured to provide an entry point for ingestion of data into the OMS.

In an implementation, the data collected by each data collection engine 306 is stored in a cache memory 314 associated with the data aggregator 302. In an implementation, the cache 314 may include a fast access memory, such that data from the cache 314 can be frequently accessed from the main memory or storage (not shown) by other components of the OMS, such as data analyzer 316 and/or metrics generator 318. In one example, the cache 314 is typically located on a processor chip or on a separate memory module and operates at a higher speed than main memory or storage. Other storage locations for the data are contemplated.

Turning now to FIG. 4, a block diagram showing workings of a data analyzer unit of an operations management system (OMS) is illustrated. It is noted that although the following description is focused on log data, systems and methods described herein can be utilized to mine various other types of data, e.g., as described in FIG. 3. Such implementations are contemplated. It is noted that one or more blocks depicted in FIG. 4 are explained with respect to FIG. 5, and these blocks are called out, as such, in the description that follows.

In an implementation, log data ingested by the OMS through the data aggregator (e.g., data aggregator 302 described in FIG. 3) is further processed by the data analyzer 402 to generate training data, and use the training data to mine log data for actionable insights. The training data can facilitate correlation of different sets of log data, collected from different data sources and heterogenous in nature.

The OMS, in one implementation, can operate in a training mode and an inference mode, as depicted. As shown in FIG. 4, the data analyzer 402 accesses data 410 ingested by a data aggregator 404. In an implementation, since ingested data 410 is heterogenous, each different type of data may have its own characteristics, such as schema, format, encapsulation mechanisms, and the like. To this end, depending on the type of data (and data source from where the data is collected), the data analyzer 402 processes the ingested data such that information related to events, metrics, logs, configurations, flow, and the like associated with a monitored service and received from different data sources can be correlated to generate actionable insights.

The data analyzer 402, in one implementation, restructures data from different sources into different data stores (not shown). In another implementation, the data analyzer 402 can retrieve data directly from a cache associated with data aggregator (e.g., cache 314 of FIG. 3). In an implementation, the data analyzer 402 processes the ingested data 410 from each database in order to decouple the data from its physical infrastructure. That is, ingested data 410 is abstracted such that the data represents performance metrics associated with operation of the service or application being monitored, and not the physical infrastructure of the service or application from where it is generated (e.g., routers, switches, hubs, repeaters, gateways, bridges, and modems, etc.). According to the implementation, the abstraction is performed by the data analyzer 402 using virtual machines and/or containers.

In an implementation, the ingested data 410 includes data with different data patterns. Exemplary data patterns included within the ingested data 410 are illustrated in FIG. 5. As shown, the ingested data 410 is made up of multiple data patterns, e.g., data patterns 1-5, as depicted using the legend in FIG. 5. In one implementation, data patterns in the ingested data 410 can be similar and/or unique.

The ingested data 410 is normalized by the data analyzer 402. This is depicted as data normalization 412 in FIG. 4. In an implementation, the ingested data 410 is normalized using a user-defined function (UDF) normalization technique. According to the implementation, with the UDF custom normalization, the data analyzer 402 utilizes user-defined functions to normalize the ingested data 410 in a database. The normalization rules are defined by the user and implemented using user-defined functions. For example, user-defined functions can include code snippets written in programming languages like SQL, Python, or Java, and can be used to perform data normalization. UDF custom normalization can also be used by data analyzer 402 to implement more complex normalization rules that are traditionally difficult to achieve using built-in database normalization techniques. In an implementation, to expand the applicability of the OMS, the data normalization may require customer-specific or application-specific strings. To accommodate this, the data analyzer 402 allows for user-defined normalization of ingested data 410.

In an implementation, once the data normalization 412 is complete, the normalized data is clustered. This is illustrated as data clustering 414. According to the implementation, the normalized data is clustered in order to generate unique data patterns and from the ingested data 410. In an implementation, unique data patterns are illustrated in FIG. 5 (unique data patterns 502). As shown, the unique data patterns 502 includes all data patterns found in the ingested data 410, considered singularly.

In one implementation, for identifying unique data patterns, the data clustering 414 operation is performed by the data analyzer 402 using any clustering algorithm such as k-means clustering, hierarchical clustering, and the like. In one implementation, data patterns are generated using a Euclidean distance as distance measurement. For example, the data analyzer 402 computes a pairwise Euclidean distance between all pairs of data points. The Euclidean distance between two points in a multi-dimensional space is calculated as the square root of the sum of squared differences between the corresponding feature values. Once the distance is computed, the data analyzer 402 specifies the number of clusters to be created, initializes cluster centroids and assigns data points to the nearest centroid based on the Euclidean distance. Further, the centroids can be recalculated based on the assigned data points and the assignment is repeated iteratively until convergence.

In an implementation, the clustered data can be re-clustered to generate unique data pattern groups. In an example, as shown in FIG. 5, the unique data pattern groups are depicted as “pattern groups 508.” According to the implementation, data patterns groups are generated by clustering the data using cosine similarity as a distance measurement. For example, for the cosine clustering, firstly already clustered data is converted into numerical vectors. Then, pairwise cosine similarity between all pairs of data points in the vectorized data is computed. Further, cosine of the angle between two vectors is calculated. This value can range between −1 and 1. For example, a value of 1 indicates the vectors are identical, 0 indicates they are orthogonal (not similar), and −1 indicates they are diametrically opposed. Once the cosine values are determined, any clustering algorithm can be applied to create clusters of data. For instance, using a k-means clustering technique, a desired number of clusters (k) are specified. The data analyzer 402 can assign data points to clusters by minimizing the sum of squared distances between data points and the cluster centers. In the case of cosine similarity, the distance is defined as “1—cosine similarity”. The data analyzer 402 can iteratively adjust the cluster centers until convergence.

In one implementation, based on the extracted data patterns 502 and pattern groups 510, corresponding meta tags associated with each data pattern 502 or group 510 are identified. The meta tags, in one example, provide contextual information associated with the data patterns, such that each meta tag identifies an event, alert, status, etc. associated with a device or service from where the log data originates. In an example shown in the figure, data correlation 416 is performed by the data analyzer 402, wherein each unique data pattern or group of patterns is associated with at least one event.

Referring back to the example depicted in FIG. 5, the meta tags identified from the data at least include identified events 504, e.g., including event 1, event 2, and event 3. Further, each data pattern from the unique data patterns 502 is associated with at least one given event 504. For instance, data patterns 1 and 5 is correlated with event 1, data patterns 2 and 3 are correlated with event 2, and data pattern 4 is correlated with event 4, respectively. According to one implementation, based on the correlation of data patterns with events 504, a lookup table 418 is generated by the data analyzer 402. The lookup table 418 includes an association of each data pattern (or pattern group) with at least one meta tag. Other fields of the lookup table can include timestamps, log data versions, data descriptions, and the like. In one example, during training mode, the lookup table is updated each time new events are identified. In an implementation, the lookup table 418 is stored as part of training data by the data analyzer 402. Further, each time new logs are ingested (e.g., in inference mode), the data analyzer 402 utilizes the training data to generate mined data from the new logs.

An exemplary lookup table 418 is as depicted in FIG. 5. As seen from the figure, the lookup table includes each identified data pattern, e.g., data pattern 1 is encountered thrice, data pattern 2 is encountered twice, and so on. Further, the lookup table 418 further includes the association of each unique data pattern and pattern group with a given event. For example, as shown in FIG. 5, pattern group 1 includes data patterns 1 and 5 and is correlated with event 1. Similarly, pattern group 2 includes data patterns 2 and 3 and is correlated with event 2. Pattern group 3 only includes data pattern 5 and is correlated to event 3. Other contemplated fields of the lookup table, as described above, are not shown to avoid obscurity. In one implementation, the lookup table 418 is stored as part of training data.

In another implementation, training data is further supplemented with entity annotation 422. As depicted in the figure, for performing entity annotation 422, entity-specific parameters are received from a meta store 440. In one example, the entity-specific parameters include inventory information, entity names, and other information associated with multiple entities. In an implementation, an NER model is trained on these entity-specific parameters, in order to identify entity-specific tags in ingested logs 410. Once the NER model is trained, entity annotation 422 is performed by the data analyzer 402, wherein entities are identified in the ingested data 410. Indications of the identified entities make another part of the training data, along with the lookup table 418.

During an inference mode (e.g., data inference 420), the data analyzer 402 uses training data to create mined data 450 from newly ingested log data. In an implementation, the mined data 450 is generated by extracting data patterns from the log data, and correlating the data patterns with events based on the lookup table 418 stored in the training data. Further, the data patterns and corresponding events are supplemented with entity-specific parameters derived from the entity-specific tags stored in the training data.

In an implementation, using the generated mined data 450, the data analyzer 402 generates a taxonomy for each entity identified in the log data. The taxonomy includes categories, each associated with at least one meta tag, such that log data can be segregated into these categories. Further, a priority value for each category of the taxonomy is determined by the data analyzer, wherein this priority value is utilized by the metrics generator 406 to generate appropriate dashboards, as described in FIG. 5. In one implementation, the training data, and therefore the resultant mined data 450 can be updated in real-time or near-real time based on user inputs or other factors.

In the implementations described herein, manual identification of data patterns and entities by an end-user is avoided. The OMS automatically extracts and bucketizes patterns into different buckets such as events, info, warning, errors, etc. In each of these buckets, extracts names of entities are automatically created to generate a dictionary of labels. The OMS described allows the end-user to track different information for each unique extracted label. Further, the need to maintain rule-based engines to parse logs, change rules when there is a change to structure of log and monitor log patterns manually to identify patterns is eliminated. Further, change to versions of software running on the user devices is automatically taken into consideration by the OMS when modifying training data.

In one implementation, the metrics generator 404, uses the mined data 450 generated by data analyzer 402 to generate dashboards. In an implementation, the metrics generator 404 is configured to receive a message from user device(s) 460 to generate dashboards for monitoring logs and create one or more dashboards to be displayed at a graphical user interface (GUI) of the user device 460 responsive to the request.

In one implementation, a natural language understanding (NLU) engine (not shown) is configured to identify one or more messages received from the user device 460. The messages, in one example, include a request in plain text to inspect log data of a given service or application. In an implementation, the NLU engine identifies the request and extracts meaning from the plain text message by determining its meaning, structure, and intent. One or more methods, such as sentiment analysis, sentence structuring, and/or other relevant models may be performed by the NLU engine to extract the meaning from the request.

In an implementation, based at least part on the extracted meaning and intent the metrics generator 406 generates multiple dashboards. As shown in the figure, the dashboards are generated based in part on the mined data 450, including data patterns and their corresponding events. In one example, a log event dashboard is generated to present a graph illustrating what events occurred for a given period of time (“inspection period”). The exemplary log event dashboard, in one example, can present a correlation of events and their respective timestamps for the inspection period. Further, each event is presented in a manner that associated priority value for the event can be observed. In an implementation, an entity associated with each event is also presented as part of the log event dashboard. In one example, the entity information and the priority values are gleaned by the metrics generator 406 using the taxonomy generated from the mined data 450.

In another example, an event count dashboard can be presented by the metrics generator 406. According to the implementation, the event count dashboard can display a correlation between an inspection period and a count of events occurred during the inspection period. Again, each parameter of the event count dashboard can be supplemented using priority values and entity-specific information from the taxonomy.

In one implementation, the user device(s) 460 can request such dashboards from the OMS, and the metrics generator 406 is configured to generate the dashboards responsive to the requests. Further, as training data is updated and/or new mined data is created, these dashboards are automatically updated in real-time, without human intervention. In an implementation, the user device(s) 460 can also send an override request when interacting with a dashboard, such that responsive to the request, the metrics generator 406 can provide an option to manually edit the dashboards. These and other implementations are contemplated.

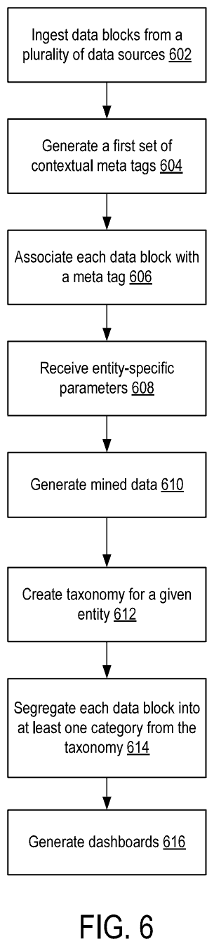

FIG. 6 illustrates a method for analyzing log data. As described in the foregoing, an operations management system (OMS) receives log data from multiple data sources and analyzes the log data to extract data patterns and associated events. In an implementation, the OMS ingests data from a plurality of data sources (block 602). The OMS ingests the data from multiple data sources, each associated with performance of elements of a particular hardware infrastructure (e.g., physical datacenters) or software infrastructure (e.g., cloud or network-based services). The data at least includes log data associated with the hardware or software infrastructure. Further, data sources can also include monitoring systems and/or log-collection systems.

In an implementation, the ingested data is unstructured and unformatted data and therefore the OMS is configured to normalize and cluster the data to generate data patterns. Further, based on the generated data patterns, contextual meta tags for the ingested data are determined (block 604). In one example, the contextual meta tags include events, warnings, alerts, and other information identified within the log data. In one implementation, each data block, i.e., data pattern or pattern groups, of the log data is associated with at least one meta tag (block 606). For instance, each data block is associated with a corresponding event or alert identified from the ingested log data. This correlated data is saved as training data.

In another implementation, entity-specific parameters are received by the OMS (block 608). In an example, the entity-specific parameters are received from a dedicated meta store (e.g., meta store 440 of FIG. 4) and these parameters include entity names, inventory information, etc. related to multiple entities. In an implementation, the ingested log data is used to train a NER model with the entity-specific parameters acting as meta tags. This results in the NER model extracting data patterns and correlating these patterns with the entity information. The NER model results are then added to the training data.

The OMS is further configured to generate mined data (block 610). In an implementation, the mined data is generated for new incoming logs, using the training data. For instance, the OMS extracts data patterns newly ingested log data and infuses event and entity information from the training data to these data patterns in order to create the mined data. The OMS further generates a taxonomy for each entity identified in the log data (block 612). In an implementation, the taxonomy includes multiple categories each indicative of a meta tag identified by the OMS. The data blocks are segregated into the categories of the taxonomy for every entity (block 614). In an implementation, the taxonomy further includes a priority value for each category, such that higher priority categories flagged to a user device when the data is presented.

In an implementation, the data is presented based on the taxonomy and priority values of categories, in the form of dashboards generated by the OMS (block 616). As described in the foregoing, the dashboards are generated in real-time when a request to access the log data is received from a given user device. Further, each dashboard can be updated in real-time when training data is updated or a user override is identified. Several dashboards such as those depicting log events, event counts, unclassified data, etc. are possible and contemplated.

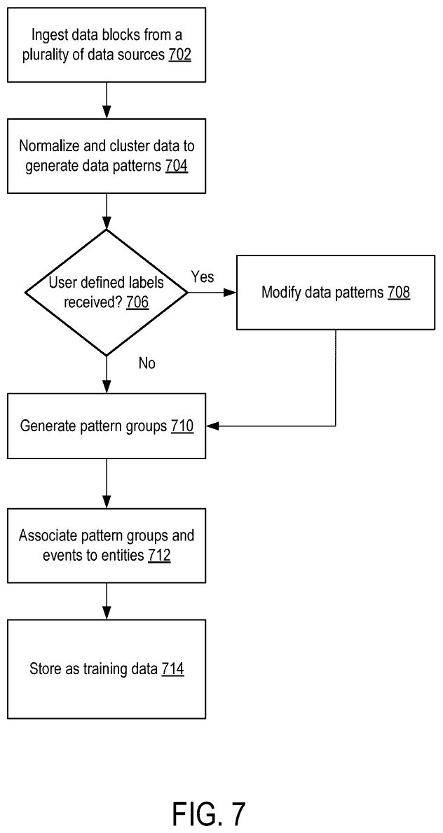

Turning now to FIG. 7, an exemplary method of generating training data from log data is illustrated. In an implementation, the OMS ingests data from a plurality of data sources (block 702). The OMS ingests the data from multiple data sources, each associated with performance of elements of a particular hardware infrastructure (e.g., physical datacenters) or software infrastructure (e.g., cloud or network-based services). The data at least includes log data associated with the hardware or software infrastructure. Further, data sources can also include monitoring systems and/or log-collection systems.

The ingested log data is then normalized and clustered to generate data patterns (block 704). In an implementation, the data is normalized using a UDF custom normalization. Further, the normalized data is clustered to create data pattern clusters. In one example, the data is clustered using a Euclidean distance as the distance measurement. The data is clustered, in an implementation, to extract data patterns from raw log data such that contextual meta tags are identified from the data patterns for generating actionable insights from unstructured and freeform log data.

The OMS is further configured to determine whether user-defined labels or tags are received (conditional block 706). In an implementation, the OMS can provide the extracted data patterns and resulting meta tags to a user device, wherein an end-user can manually add or modify the contextual meta tags. If such labels are received (conditional block 706, “yes” leg), the data patterns are modified to reflect these labels (block 708). The method then continues to block 710. If no such labels are received, (conditional block 706, “no” Jeg), the OMS generates unique pattern groups from the extracted data patterns (block 710). In one implementation, the unique pattern groups are created by re-clustering the data patterns, e.g., using a cosine similarity as a distance measurement.

The data patterns and the pattern groups, in one implementation, are analyzed by the OMS to identify events associated with each pattern or group. Further, these patterns and groups, along with associated events, are associated with entity information (block 712). In an implementation, the entity information is generated using NER models for entity annotation, wherein entity-specific parameters are used to train the NER models in order to identify unique entity-based tags from ingested log data. The data patterns, supplemented with the event information and the entity information is subsequently stored as training data (block 714). In one implementation, the generation of the training data is performed by the OMS, while operating in a training mode.

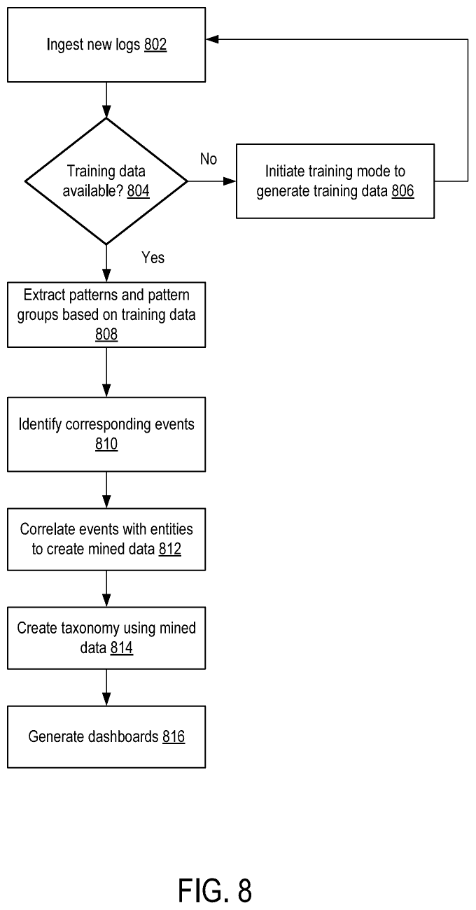

Turning now to FIG. 8, an exemplary method of generating mined data using training data is illustrated. In an implementation, during an inference mode, the OMS ingests new log data from a plurality of data sources (block 802). The OMS then determines whether training data is available (conditional block 804). As described in the foregoing, training data is generated by the OMS when it is operating in a training mode, based on analysis of log data. If such training data is unavailable (conditional block 802, “no” leg), the OMS initiates the training mode to generate training mode to generate training data (block 806). In one implementation, the training mode is automatically initiated when training data is unavailable or existing training data needs updating (e.g., due to version changes in log data, user override commands, etc.). The method then continues to block 802, where new logs are again ingested.

However, if training data is available (conditional block 802, “yes” leg), the OMS is configured to extract patterns and pattern groups from the ingested log data (block 808). Further, corresponding events associated with each data pattern and pattern groups are also identified (block 810). As described in the foregoing, corresponding events are identified using a lookup table from the training data including previously extracted data patterns and identified events.

In an implementation, the data patterns with correlated events are supplemented with entity information to create mined data (block 812). In an example, the entity information can also be accessed from previously generated training data. Further, for each identified entity, a taxonomy is created including multiple categories, each indicative of at least one event or other meta tag (block 814). In an implementation, the taxonomy includes categories such as events, warning, alerts, etc. and data pattern segregated in each of these categories. Further, a priority value for each category is also included within the taxonomy.

Based on the taxonomy, the OMS generates dashboards for presentation to a user device (block 816). In one implementation, the dashboards indicate each category with their respective priority values and the data patterns included in each category. The dashboards are created and updated in real-time based on requests received from the user device. Also, each time the training data, (and consequently the mined data) is updated, the OMS can automatically update the dashboards.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a processing unit configured to:
ingest a plurality of data blocks from one or more data sources associated with a plurality of network-connected devices;
associate each data block with one or more contextual meta tags identified from the ingested plurality of data blocks;
identify one or more entities associated with the at least one network-connected device, based at least in part on the association;
create, for a given entity, a taxonomy comprising a plurality of categories, wherein each category comprises at least one contextual meta tag; and
generate one or more dashboards for presentation at a user interface of a user device based at least in part on the taxonomy.

2. The system as claimed in claim 1, wherein the processing unit is further configured to:
process each data block of the plurality of data blocks to identify one or more data patterns; and
identify the one or more contextual meta tags from the ingested plurality of data blocks based at least in part on the data patterns.

3. The system as claimed in claim 2, wherein the processing unit is further configured to associate each data pattern with at least one contextual meta tag.

4. The system as claimed in claim 1, wherein the one or more contextual meta tags comprise entity-specific parameters, and wherein the processing unit is further configured to:
receive the entity-specific parameters from a meta store associated with the at least one network-connected device, wherein the entity-specific parameters at least in part comprise inventory information associated with the one or more entities; and
identify the given entity associated with the at least one network-connected device based on the entity-specific parameters.

5. The system as claimed in claim 4, wherein the given entity is identified at least based in part on training a Named Entity Recognition (NER) model on the entity-specific parameters.

6. The system as claimed in claim 1, wherein the processing unit is further configured to:
segregate each data block into at least one category from the plurality of categories;
determine a priority level for each category comprised within the taxonomy; and
generate the one or more dashboards for presentation at the user interface of the user device, based at least in part on the priority level of each category of the plurality of categories.

7. The system as claimed in claim 1, wherein the processing unit is further configured to:
decouple each ingested data block from its data source;
normalized the decoupled data;
identify at least one label for the decoupled data to generate labeled data; and
generate the contextual meta tags comprising the labeled data.

8. A method comprising:
ingesting, by an operations management system, a plurality of data blocks from one or more data sources associated with a plurality of network-connected devices;
associating, by the operations management system, each data block with one or more contextual meta tags identified from the ingested plurality of data blocks;
identifying, by the operations management system, one or more entities associated with the at least one network-connected device, based at least in part on the association;
creating, by the operations management system for a given entity, a taxonomy comprising a plurality of categories, wherein each category comprises at least one contextual meta tag; and
generating, by the operations management system, one or more dashboards for presentation at a user interface of a user device based at least in part on the taxonomy.

9. The method as claimed in claim 8, further comprising:
processing, by the operations management system, each data block of the plurality of data blocks to identify one or more data patterns; and
identifying, by the operations management system, the one or more contextual meta tags from the ingested plurality of data blocks based at least in part on the data patterns.

10. The method as claimed in claim 9, further comprising associating, by the operations management system, each data pattern with at least one contextual meta tag.

11. The method as claimed in claim 8, wherein the one or more contextual meta tags comprise entity-specific parameters, and wherein the method further comprising:
receiving, by the operations management system, the entity-specific parameters from a meta store associated with the at least one network-connected device, wherein the entity-specific parameters at least in part comprise inventory information associated with the one or more entities; and
identifying, by the operations management system, the given entity associated with the at least one network-connected device based on the entity-specific parameters.

12. The method as claimed in claim 11, wherein the given entity is identified at least based in part on training, by the operations management system, a Named Entity Recognition (NER) model on the entity-specific parameters.

13. The method as claimed in claim 1, further comprising:
segregating, by the operations management system, each data block into at least one category from the plurality of categories;
determining, by the operations management system, a priority level for each category comprised within the taxonomy; and
generating, by the operations management system, the one or more dashboards for presentation at the user interface of the user device, based at least in part on the priority level of each category of the plurality of categories.

14. The method as claimed in claim 1, further comprising:
decoupling, by the operations management system, each ingested data block from its data source;
normalizing, by the operations management system, the decoupled data;
identifying, by the operations management system, at least one label for the decoupled data to generate labeled data; and
generating, by the operations management system, the contextual meta tags comprising the labeled data.

15. A computing system comprising:
a central processing unit; and
an operations management unit configured to:
ingest a plurality of data blocks from one or more data sources associated with a plurality of network-connected devices;
associate each data block with one or more contextual meta tags identified from the ingested plurality of data blocks;
identify one or more entities associated with the at least one network-connected device, based at least in part on the association;
create, for a given entity, a taxonomy comprising a plurality of categories, wherein each category comprises at least one contextual meta tag; and
generate one or more dashboards for presentation at a user interface of a user device based at least in part on the taxonomy.

16. The system as claimed in claim 15, wherein the operations management unit is further configured to:
process each data block of the plurality of data blocks to identify one or more data patterns; and
identify the one or more contextual meta tags from the ingested plurality of data blocks based at least in part on the data patterns.

17. The system as claimed in claim 16, wherein the operations management unit is further configured to associate each data pattern with at least one contextual meta tag.

18. The system as claimed in claim 15, wherein the one or more contextual meta tags comprise entity-specific parameters, and wherein the operations management unit is further configured to:
receive the entity-specific parameters from a meta store associated with the at least one network-connected device, wherein the entity-specific parameters at least in part comprise inventory information associated with the one or more entities; and
identify the given entity associated with the at least one network-connected device based on the entity-specific parameters.

19. The system as claimed in claim 18, wherein the given entity is identified at least based in part on training a Named Entity Recognition (NER) model on the entity-specific parameters.

20. The system as claimed in claim 15, wherein the operations management unit is further configured to:
segregate each data block into at least one category from the plurality of categories;
determine a priority level for each category comprised within the taxonomy; and
generate the one or more dashboards for presentation at the user interface of the user device, based at least in part on the priority level of each category of the plurality of categories.
